(19) United States
(12) Patent Application Publication
(10) Pub. No.: US 2023/0343930 A1
(43) Pub. Date: Oct. 26, 2023

(54) GRAPHITE/LITHIUM HYBRID NEGATIVE ELECTRODE

(71) Applicant: SAFT, LEVALLOIS PERRET (FR)

(72) Inventors: Christian JORDY, ST LOUIS DE MONTFERRAND (FR); Vincent PELE, BORDEAUX (FR)

(73) Assignee: SAFT, LEVALLOIS PERRET (FR)

(21) Appl. No.: 18/011,938

(22) PCT Filed: Jun. 25, 2021
(86) PCT No.: PCT/EP2021/067485

§ 371 Date: Dec. 21, 2022

(30) Foreign Application Priority Data
Jun. 26, 2020 (FR) FR20 06745

(51) Int. Cl. H01M 4/36; H01M 4/587; H01M 4/38; H01M 10/0562; H01M 10/052; H01M 4/133; H01M 4/134

(52) U.S. Cl. CPC H01M 4/364; H01M 4/587; H01M 4/382; H01M 4/386; H01M 10/0562; H01M 10/052; H01M 4/133; H01M 4/134; H01M 2004/027

(57) ABSTRACT

The present invention provides a mixed porous negative electrode comprising graphite and solid electrolyte particles, the structure and composition of which make it possible to increase the amount and quality of the lithium deposition while avoiding large variations in thickness.

### CROSS REFERENCE TO RELATED APPLICATIONS

The present application is a U.S. National Phase Application under 35 U.S.C. § 371 of International Patent Application No. PCT/EP2021/067485 filed Jun. 25, 2021, which claims priority of French Patent Application No. 20 06745 filed Jun. 26, 2020. The entire contents of which are hereby incorporated by reference.

### FIELD OF THE INVENTION

The present invention relates to the field of energy storage, and more precisely to batteries, in particular lithium batteries.

### BACKGROUND

Lithium-ion rechargeable batteries offer excellent energy and volume densities and currently occupy a prominent place in the market of portable electronics, electric and hybrid vehicles or stationary systems for energy storage.

Moreover, solid electrolytes offer a significant improvement in terms of safety insofar same carry a much lower risk of flammability than liquid electrolytes.

The operation of lithium batteries is based on the reversible exchange of the lithium ion between a positive electrode and a negative electrode, which are separated by an electrolyte, lithium being deposited at the negative electrode during the charging operation. Controlling the homogeneous working of a lithium metal negative electrode is however, very delicate (growth of dendrites, deterioration of mechanical properties related to variations in the electrode volume, instabilities at interfaces).

It is thus desirable to promote the deposition of lithium and to obtain a deposition as homogeneous as possible.

FR2 992 478 describes a negative electrode, in particular for a lithium-ion cell, comprising lithium titanate and graphite. U.S. Pat. No. 2019/0190012 describes a hybrid negative electrode for lithium-ion batteries comprising a hybrid electroactive material comprising graphite or silicon, and lithium titanate.

Solid electrodes make it possible to obtain high current surface densities but have the drawback of leading to the formation of dendrites and to an inhomogeneous deposition of lithium which ultimately leads to the limitation of the charge.

Electrochemically active negative electrode materials for which the electrochemical capacity is highest generally consist of a metal apt to form an alloy with lithium or pure lithium metal. However, such materials have a strong volume expansion during lithiation. Such expansion will be the origin of the deterioration of a Li-ion cell based on the negative electrode material: I) deterioration of the integrity of the electrode which leads to a decrease in the electrode capacity, ii) fracture of the electrode-electrolyte interface (or SEI for “Solid electrolyte Interface”) which leads to the continuous formation of deterioration products, iii) addition of stresses over the entire battery and deterioration of the other components.

It is therefore desirable to make available a negative electrode the structure and composition of which allow the volume capacity of the electrode to be increased while avoiding large variations in thickness.

### SUMMARY

Thus, the invention aims in particular to provide a mixed porous negative electrode comprising graphite and solid electrolyte particles, characterized in that: during the charging process, said electrode further contains:
lithium-metal or in the form of a lithium-rich alloy within the porosity thereof and
lithium in the form of lithiated graphite.

Said electrode is suitable for use in an energy storage device.

The term “negative electrode” refers to the electrode working as an anode, when the battery is discharging, and to the electrode working as a cathode when the battery is charging, the anode being defined as the electrode where an electrochemical oxidation reaction (electron emission) takes place, while the cathode is the seat of the reduction.

The term negative electrode refers to the electrode from which the electrons leave, and from which the cations (Li₊) are released during discharging.

The term “lithium-rich alloy” refers to an alloy comprising at least 85% (atomic) of lithium.

The electrode structure according to the invention thus makes possible a homogeneous deposition of lithium within the porous structure while strongly limiting the volume variations of the electrode.

According to one embodiment, the negative electrode according to the invention does not contain lithium-metal before same starts working. Nevertheless, while working within a charging electrochemical cell, the negative electrode further comprises lithium-metal within the porosity thereof, said lithium being
in the form of metal and/or a lithium-rich alloy within the porosity thereof and
in the form of lithiated graphite.

The electrode is “hybrid” in that same allows lithium to be inserted into the host material (lithiated graphite) and to be deposited in metallic form and/or in a lithium-rich phase in the porosity of the electrode.

Li is inserted during the charging process according to a 3D structure.

The electrode according to the invention can be described as “mixed”, in that it can be considered as a Li-ion type electrode and comprises lithium during the charging process.

The negative electrode layer generally consists of a conducting support used as a current collector which is coated with the negative electrode according to the invention containing said solid electrolyte particles and said graphite particles.

Current collector refers to an element such as a pad, plate, sheet or other, made of conducting material, connected to the positive or to the negative electrode, and conducting the electron flow between the electrode and the terminals of the battery.

The current collector is preferentially a two-dimensional conducting support such as an either solid or perforated strip, containing metal, e.g. copper, nickel, steel, stainless steel or aluminum Said collector with the negative electrode is generally in the form of a copper strip.

According to one embodiment, said electrode can further contain a binder.

“Binder” refers to materials which can impart to the electrode the cohesion of the different components and the mechanical strength thereof on the current collector, and/or can impart a certain flexibility to the electrode for the use thereof in a cell. The binders include polyvinylidene fluoride (PVDF) and the copolymers thereof, polytetrafluoroethylene (PTFE) and the copolymers thereof, polyacrylonitrile (PAN), poly(methyl)- or (butyl)methacrylate, polyvinyl chloride (PVC), poly(vinyl formal), polyester, block polyetheramides, acrylic acid polymers, methacrylic acid, acrylamide, itaconic acid, sulfonic acid, elastomer and cellulosic compounds. The elastomer or elastomers which can be used as a binder can be chosen from styrene-butadiene (SBR), butadiene-acrylonitrile (NBR), hydrogenated butadiene-acrylonitrile (HNBR), and a mixture of a plurality thereof.

According to one embodiment, lithium is not in the form of lithium titanate.

According to one embodiment, the negative electrode further contains a “lithiophilic” material. The expression “lithiophilic” defines a material with an affinity for lithium, (i.e.) the ability thereof to form alloys with lithium.

According to one embodiment, the lithiophilic element can be chosen from silicon, silver, zinc and magnesium, preferentially silicon. Typically, the alloys formed by said elements with lithium include LiₓSi_{y}, with variable atomic ratios x/y. The lithiophilic element can be present in the form of particles or fibers instead of or in addition to the coating. Preferentially, at least one of the characteristic dimensions of such particles or fibers is less than 1 μm

Such lithiophilic element can be added by adding the powder of said element with the graphite during the manufacture of the electrode.

According to one embodiment, the graphite is coated with a lithiophilic element, preferentially chosen from silicon, zinc, aluminum, silver, magnesium, tin, or compounds containing such elements.

The layer of lithiophilic element mentioned herein, which coats the graphite particles typically has a thickness which can vary from a few nanometers to less than 100 nm, typically less than 50 nm, in particular less than 20 nm, in particular less than 10 nm, more preferentially from 2 to 5 nm.

Such layer has a plurality of roles. The layer reduces the nucleation energy of lithium. The layer is conducting with regard to lithium, in that same allows Li₊ ions to transit from the electrolyte layer. Moreover, said layer can further makes possible a homogenization of the lithium deposition by allowing local batteries to be formed: indeed, during charging, a difference of potentials is created in the thickness of the electrode; such potential difference can then make possible an electrochemical rebalancing over the thickness of the electrode through the oxidation of metallic lithium in the areas with the most positive potentials and a reduction of Li₊ in the areas with the most negative potentials.

According to one embodiment, the coating layer consists exclusively of the lithiophilic material.

The graphite particles can be coated over all or a part of the peripheral surface hereof. According to one embodiment, the coating layer covers at least 50% of the surface of the electrode, preferentially at least 75%, more preferentially at least 90%, even more preferentially at least 95%.

According to the invention, the negative electrode is porous:

The volume of the pores makes it possible to receive lithium in the metallic state during the charging process.

“Porous” according to the invention refers to a pore size of less than 300 nm.

The pore size corresponds to the structure of the material having an organized network of channels of very small variable pore size: typically a pore size, in particular D50, of less than 1 μm, preferentially less than 300 nm. The pore size imparts to the electrode a particularly large active surface area per unit of electrode surface area.

According to one embodiment, the electrode has a porosity comprised between 10 and 60%, preferentially between 30 and 50%, the porosity representing the percentage of voids in the total volume of the formulation considered.

The porosity thus defined in terms of volumes can be measured in particular by helium or mercury intrusion porosimetry. Same can be achieved by using a porosimeter and in particular allows the distribution of pore volumes to be measured via the inlet diameter of the pores. Same provides access to the pore size distribution.

The porosity can also be based on the thickness, the mass of the treated electrode and the composition of the electrode and the density of the components. According to the invention, the porosity makes it possible in particular to receive the lithium metal within the porosity and to maintain the mechanical strength of the electrode.

Graphite particles are not limited in terms of the morphology thereof. Spherical or ovoid particles, platelets, etc. are included.

Typically, the graphite particles have a mean diameter comprised between 1 and 30 μm nominal (or equivalent). The mean diameter can be measured by a method conventionally used for measuring the size of the powder particles, in particular with a laser granulometer.

A mixture of several particle sizes and several graphite morphologies can also be used.

The electrolyte can be either solid or not, preferentially solid.

According to one embodiment, the solid electrolyte is a sulfide.

Typically, said sulfide electrolyte can be chosen from:
all phases [(Li₂S)_{y}(Li₂O)ₜ(P₂S₅)_{1-y-t}]_{1-z)}(LiX)_{z} with X representing a halogen element; 0<y<1; 0<z<1; 0<t<1
argyrodites such as Li₆PS₅X, with X=Cl, Br, I, or Li₇P₃S₁₁;
Sulfide electrolytes having the crystallographic structure equivalent to the compound Li₁₀GeP₂S₁₂;
Li₃PS₄.

According to another subject matter, the present invention further relates to a process for preparing an electrode according to the invention, said process comprising the step of mixing graphite, coated beforehand if appropriate, particles of solid electrolyte and a pore-forming agent, then a treatment for removing the pore-forming agent, such as a heat treatment of the mixture obtained.

It is understood that the mixture can further comprise a lithiophilic element powder according to the embodiment as discussed above. Pore-forming agents include in particular polypropylene carbonate. Typically, the content of the pore-forming agent in the mixture is comprised between 10 and 50% by weight.

Porosity can then be created by a treatment making it possible to remove the pore-forming agent, by application or adaptation of known methods, generally depending on the nature of the pore-forming agent used. Typically, the above can be achieved by heat treatment, at a temperature generally greater than 150° C.

The prior coating of graphite particles with a lithiophilic element can be carried out by any method for the deposition of a thin layer, such as:
chemical deposition: sol-gel, spin coating, vapor phase deposition, atomic layer deposition (ALD), molecular layer deposition (MLD), or by controlled oxidation; and
Physical vapor deposition (PVD): vacuum evaporation, sputtering, pulsed laser deposition, electrohydrodynamic deposition.

Typically, the coating layer can be deposited by ALD or PVD.

ALD consists in successively exposing the surface of carbon particles to different chemical precursors in order to obtain ultra-thin layers.

Deposition can generally be performed by ALD, PVD. Typically, the PVD treatment is carried out on a fluidized bed for a homogeneous deposition, (i.e.) a treatment of the particles in all directions.

According to another subject matter, the present invention further relates to an all-solid electrochemical element comprising a porous negative electrode according to the invention, and a positive electrode, such that the ratio k=C_{negative material}/Cₚₒₛᵢₜᵢᵥₑ is comprised between 0.2 and 0.95, preferentially between 0.5 and 0.9, where C_{negative material} is the sum of the capacity of graphite and of a part of the capacity of all lithiable materials present at the negative electrode in the discharged state. The part of capacity considered is the part the potential of which, measured during a discharge at C/100, is greater than 0.2V vs Li⁺/Li^{○}. The capacities are equal to the products of the area density [N.tr.: incorrectly referred to as “mass” in the French original] of each active material multiplied by the specific capacity (the area densities [N.tr.: incorrectly referred to as “masses” in the French original] being expressed in g/cm² and the specific capacities in mAh/g, the active materials of the negative electrode including graphite as well as the other lithiable materials), and where Cₚₒₛᵢₜᵢᵥₑ represents the capacity of the positive electrode in mAh/cm².

According to one embodiment, the porosity of the negative electrode in the discharged state (expressed in percent) is equal to 100*R*(1−k)*Cₚₒₛᵢₜᵢᵥₑ*4.85/e where: Cₚₒₛᵢₜᵢᵥₑ represents the areal capacity of the positive electrode in mAh/cm² e represents the thickness of the negative electrode in the discharged state, expressed in μm R represents a number between 0.6 and 3, preferentially between 1.1 and 1.7 and k is as defined above.

According to one embodiment, the electrochemical element comprises an intermediate layer comprised between the negative electrode and the solid electrolyte layer which is used as a separator; such layer mainly contains fine amorphous carbon powder and a lithiophilic element forming alloys with lithium. The carbon powder and the powder of the lithiophilic element are preferentially of nanometric size (between 20 and 100 nm). The lithiophilic element can be different from the element used in the negative electrode.

“Electrochemical cell” refers to an elementary electrochemical cell consisting of the positive electrode/electrolyte/negative electrode assembly, making it possible to store the electrical energy supplied by a chemical reaction and to release the energy in the form of a current.

Typically, such an electrochemical cell comprises a negative electrode layer, a positive electrode layer and an electrolytic separation layer, such that said solid electrolyte particles are present within the three layers.

It is understood that the solid electrolyte particles present in the different layers can be identical or different.

In the context of the present invention, the positive electrode of the positive electrode layer can be of any known type.

The term positive electrode refers to the electrode where the electrons enter, and where the cations (Li₊) arrive during the discharge process.

The positive electrode layer generally consists of a conducting support used as a current collector which is coated with the positive electrode containing the positive electrode active material, solid electrolyte particles and a carbon additive.

This carbon additive is distributed across the electrode so as to form an electronic percolating network between all the particles of the active material and the current collector.

Typically, the positive electrode can also comprise a binder, such as the above-mentioned binders for the negative electrode.

The active material of the positive electrode is not particularly limited. Same can be chosen from the following groups or the mixtures thereof:
a compound (a) with the formula LiₓM_{1-y-z-w}M′_{y}M″, _{z}M″″WO₂ (LMO2) where M, M′, M″ and M″″ are selected from the group consisting of B, Mg, Al, Si, Ca, Ti, V, Cr, Mn, Fe, Co, Ni, Cu, Zn, Y, Zr, Nb, W, and Mo provided that at least M or M′ or M″ or M″″ is selected from Mn, Co, Ni, or Fe; M, M′, M″ and M″″ being different from each other; and 0.8≤x≤1.4; 0≤y≤0.5; 0≤z≤0.5; 0≤w≤0.2 and x+y+z+w<2.1;
a compound (b) with the formula LiₓMn_{2-y-z}M′_{y}M″_{z}O₄ (LMO) where M′ and M″ are selected from the group consisting of Mg, Al, Si, Ca, Ti, V, Cr, Fe, Co, Ni, Cu, Zn, Y, Zr, Nb, and Mo; M′ and M″ being different from each other, and 1≤x≤1.4; 0≤y≤0.6; 0≤z≤0.2;
a compound (c) with the formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb, and Mo; and 0.8≤x≤1.2; 0≤y≤0.6;
a compound (d) with the formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb, and Mo, with 0.8≤x≤1.2; 0≤y≤0.6; 0≤z≤0.2;
a compound (e) with the formula XLi₂MnO₃; (1−x) where M is at least one element selected from Ni, Co and Mn and x≤1.
a compound (f) with formula Li_{1+X}MO_{2-y}F_{y} with a cubic structure where M represents at least one element selected from the group consisting of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm and where 0≤x≤0.5 and 0≤y≤1;
Graphite
Silicon
a titanium dioxide and a niobium TNO having the formula (g): LiₓTi_{a-y}M_{y}Nb_{b-z}M′_{z}O_{((x+4a+5b)/2)-c-d}X_{c}
where 0≤x≤5; 0≤y≤1; 0≤z≤2; 1≤a≤5; 1≤b≤25; 0.25≤a/b≤2; 0≤c ≤2 and 0≤d≤2; a−y>0; b−z>0;
M and M′ each represent at least one element selected from the group consisting of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X represents at least one element selected from the group consisting of S, F, Cl and Br.

The index d represents an oxygen gap. The index d can be less than or equal to 0.5.

Said at least one titanium and niobium oxide can be chosen from TiNb₂O₇, Ti₂NB₂O₉ and Ti₂NB₁₀O₂₉.
a lithiated titanium oxide or a titanium oxide apt to be lithiated. LTO is selected from the following oxides:
h) Liₓ₋ₐMₐTi_{y-b}M′_{b}O_{4-c-d}X_{c} wherein 0<x≤3; 1≤y≤2.5; 0≤a≤1; 0≤b≤1; 0≤c≤2 and −2.5≤d≤2.5;
M represents at least one element selected from the group consisting of Na, K, Mg, Ca, B, Mn, Fe, Co, Cr, Ni, Al, Cu, Ag, Pr, Y, and La;
M′ represents at least one element selected from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y, and Eu;
X represents at least one element selected from the group consisting of S, F, Cl, and Br;
The index d represents an oxygen gap. The index d can be less than or equal to 0.5.
i) HₓTi_{y}O₄ wherein 0≤x≤1; 0≤y≤2, and
(j) a mixture of the compounds h) to i).

Examples of lithiated titanium oxides belonging to group h) are spinel Li₄Ti₅O₁₂, Li₂TiO₃ ramsdellite Li₂Ti₃O₇, LiTi₂O₄, LiₓTi₂O₄, with 0<x≤2 and Li₂Na₂Ti₆O₁₄.

A preferred LTO compound has the formula Li₄₋ₐMₐTi_{5-b}M′_{b}O₄, e.g. Li₄Ti₅O₁₂, which is also written Li_{4/3}Ti_{5/3}O₄.

The positive electrode electronic conducting material is generally selected from graphite, carbon black, acetylene black, soot, graphene, carbon nanotubes or a mixture thereof.

The current collector of the positive electrode layer is typically made of aluminum.

The electrolyte layer (or separator) contains an electrolyte composition, which can include one or a plurality of electrolyte constituents. Solid electrolyte constituents include in particular sulfur-containing compounds alone or mixed with other constituents, such as polymers or gels. Either partially or fully crystallized sulfides as well as amorphous solids, are included. Examples of such materials can be selected from sulfides with the composition A Li₂S—B P₂S₅(with 0<A<1.0<B<1 and A+B=1) and the derivatives thereof (e.g. with LiI, LiBr, LiCl, etc. doping); sulfides with argyrodite structure; or having a crystallographic structure similar to the compound LGPS (Li₁₀GEP₂S₁₂), and the derivatives thereof. Electrolytic materials can also include oxysulfides, oxides (garnet, phosphate, anti-perovskite, etc.), hydrides, polymers, gels or ionic liquids conducting lithium ions.

Examples of sulfide electrolytic compositions are described in particular in Park, K. H., Bai, Q., Kim, D. H., Oh, D. Y., Zhu, Y., Mo, Y., & Jung, Y. S. (2018). Design Strategies, Practical Considerations, and New Solution Processes of Sulfide Solid Electrolytes for All-Solid-State Batteries. Advanced Energy Materials, 1800035.

In elements of the all-solid type, the electrolytic compounds can be included in the electrolytic layer but can also be included in part within the electrodes.

Typically, the electrochemical cell according to the invention is a “lithium free” battery.

It is understood that the term “lithium free” defines the fact that the battery does not contain lithium-metal during the mounting of the battery, but that lithium is deposited in metallic form and then consumed in situ, in a controlled and reversible manner, during the battery operation. Typically, lithium is deposited within the negative electrode during charging and consumed during discharging.

According to another subject matter, the present invention further relates to an electrochemical module comprising a stack of at least two elements according to the invention, every element being electrically connected to one or a plurality of other elements.

The term “module” thus refers herein to the assembly of several electrochemical elements, said assemblies possibly being in series and/or parallel.

Another subject matter of the invention is also a battery comprising one or a plurality of modules according to the invention.

“Battery” or accumulator refers to the assembly of a plurality of modules according to the invention.

According to one embodiment, the batteries according to the invention are accumulators the capacity of which is greater than 100 mAh, typically 1 to 100 Ah.

### BRIEF DESCRIPTION OF THE DRAWINGS

FIG. 1 schematically shows the ratio between the capacity of the negative electrode (N on the left) and the positive electrode (P on the right). Such as shown, the capacity of the negative electrode in the charged state is the sum of the capacity of the lithium metal (C_{Li}) accumulated during charging, and the sum of the capacity of the graphite and of the part of the capacity of all the lithiable materials present at the negative electrode in the discharged state the potential of which during discharge is greater than 0.2V (C_{g}). Such total capacity in the charged state is equal to the capacity of the positive electrode. In other words, the capacity of the negative electrode can increase during charging by the addition of lithium, until reaching the capacity of the positive electrode.

FIG. 2 is a schematic representation of the structure of an electrochemical element according to the invention, in the discharged state. The element comprises a negative electrode layer (1), a positive electrode layer (3), separated by an electrolytic layer (2).

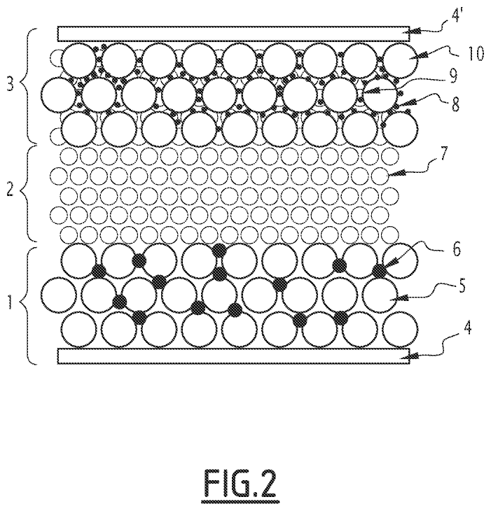

### DETAILED DESCRIPTION

The negative electrode layer (1) comprises a current collector (4) on which the negative electrode material according to the invention is deposited, consisting of solid electrolyte particles (5) and graphite particles (6).

It is understood that according to embodiments not shown herein, the particles (6) can be covered with a lithiophilic metal.

The electrolyte particles (5) and graphite particles (6) create a porosity inside which lithium metal can be deposited during charging (not shown herein). The separation layer (2) is made of solid electrolyte particles (7). The particles (7) can be identical to the particles (5).

The positive electrode layer (3 ) comprises a current collector (4′) on which is deposited, a mixture comprising solid electrolyte particles (9), conducting carbon (8)and active material particles (10).

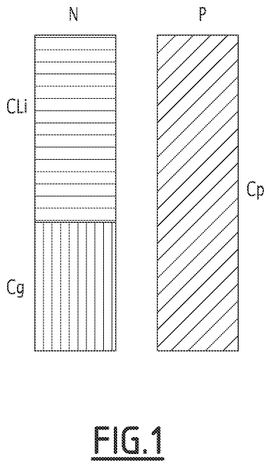

It is understood that the layers (1) and (3) can further comprise binders, which are not shown in FIG. 1.

### EXAMPLES

### 1—Preparation of Negative Electrodes

The electrolytes used to illustrate the invention are sulfide compounds with the composition Li₃PS₄, (Li₃PS₄)_{0.8}(LiI)_{0.2} and Li₆PS₅Cl. The graphite powder is of the platelet type (e.g. SFG15 from Imerys) the conducting additive used in the examples is carbon black (type C65 from Imerys). The solid electrolyte and carbon are mixed with a binder (1% PTFE), a lithiophilic material such as Zn, Ag, Mg and Si and a pore-forming agent (polypropylene carbonate), the amount of which is calculated so as to have the desired porosity after the decomposition heat treatment applied to the agent. The mixing of the powders is carried out manually in a glove box in an agate mortar by mixing 500 mg of mixture for 10 minutes, with a pestle. A quantity of such mixture is placed in a pellet mold the matrix of which has an inside diameter of 1 cm; the weight of the mixture is equal to the weight per unit area of the electrode multiplied by the inside surface area of the matrix. The blend is compressed to a pressure comprised between 1 and 5 t/cm2. The lithiophilic material can be used in several forms: either in the form of a fine powder (particles with a size comprised between 30 nm and 200 nm), or the material was deposited, by PVD, on the electrolyte powder or on the carbon powder. The method used is cathode sputtering with a rotating chamber allowing the particles to move and thus obtaining a more homogeneous deposition on the surface of the particles.

### 2—Producing the Accumulator

The positive electrode used in the examples consists of an NMC active material (composition: Li(Ni_{0.60}Mn_{0.20}Co_{0.20})O₂), sulfide electrolyte composition (Li₃PS₄)_{0.8}(LiI)_{0.2} and PTFE. The respective proportions are 74.5%, 25% and 0.5%. The constituents are mixed for 5 minutes in an agate mortar in a glove box.

The weight of the mixture in mg for the production of the electrode is equal to the desired areal capacity in mAh/cm² multiplied by the surface area of the electrode and divided by 190 mAh/g.

In the pellet mold containing the negative electrode pellet, 50 mg of electrolyte (Li₃PS₄)_{0.8}(LII)_{0.2} are added to form the electrolytic layer for providing the electronic insulation between the 2 electrodes. The whole assembly is then compressed at 5 t/cm². The mass of positive electrode mixture is then added onto the surface of the electrolyte layer, then a new compression of the whole assembly is carried out at 5 t/cm².

The pellet thus obtained is then heat-treated at 260° C. under argon for 15 minutes, so as to remove the pore-forming agent.

The assembly is then placed in a sealed electrochemical cell for the electrical connection with the positive and negative electrodes, while maintaining a mechanical pressure of about 50 bar. The cell is then charged at C/20 up to a potential of 4.3V. The total capacity of the positive electrode considered in Tables 1 and 2 corresponds to the charged capacity of 1^{st} charge divided by the surface area of the electrode.

Due to partial irreversibility of the positive electrode capacity, the total capacity cannot be measured in subsequent cycles.

One way to measure the total capacity after the 1^{st} cycle consists of charging the accumulator to the maximum nominal potential of the accumulator (in our example 4.3V) at a slow speed (typically C/20), then disassembling the accumulator in a glove box, recovering a sample of known surface area (if the electrode is double-sided, the surface area considered has to be multiplied by 2). Still in a glove box, the electrode sample is placed in a sealed cell of known volume equipped with pressure and temperature sensors as well as with a septum. Using a syringe filled with water, water is introduced into the cell on the electrode (the electrode has to be fully impregnated). The lithium in the metallic state in the electrode will thus react with water to form hydrogen. Once the cell pressure has stabilized, the number of moles of hydrogen formed (n_{H2}) can be calculated from the cell pressure, temperature and volume. The total areal capacity of the positive electrode in mAh/cm² is equal to n_{H2}*53600/S, S being the previously considered negative electrode surface area expressed in cm².

The porosity of the negative electrode is estimated as follows: a negative electrode is prepared under the conditions described in paragraph 1. A heat treatment is then applied at 260° C. for 15 minutes, under argon. The porosity is then conventionally calculated from the thickness, the weight of the treated electrode and the composition of the electrode and the density of the components.

For the calculation of the quantities C_{negative material} and k, it is necessary to measure the specific capacity of the materials forming lithium alloys used in the examples. The specific capacity can be determined as follows:
an electrode containing the material considered is produced by mixing the active material with carbon (e.g. 10%) and a binder (e.g. 5%) according to conventional processes for preparing lithium-ion batteries
An accumulator is assembled with this electrode, a metallic lithium counter-electrode, a membrane separator and an electrolyte containing carbonate solvent and LiPF6
after performing a lithiation (*) of the material considered, up to a battery potential of 0V at a C/50 rate, a delithiation is performed at a C/100 rate to a potential of 2V. Since the lithium counter-electrode has a potential equal to 0 at rest, the measurement of the accumulator voltage is approximately equal to that of the potential of the electrode containing the material considered when the rate is low (e.g. C/100)
the specific capacity of the material is equal to the discharged capacity between 0.2V and 2V divided by the weight of material considered (*) lithiation corresponds to the mechanism which occurs during the charging of the negative electrode as an accumulator in the configuration of the invention, i.e. using a counter-electrode with a high potential (typically greater than 3V); similarly, delithiation corresponds to the discharge of the negative electrode in the configuration of the invention.

For the thickness measurement needed for calculating the swelling of the negative electrode: the electrochemical cell is disassembled in the charged state and the assembly is then placed in a scanning electron microscope with which it is possible to measure the thickness of the negative electrode.

The examples of the invention and the results obtained are shown together in Tables 1 and 2. The comparative examples in Tables 4-6 were prepared using the same procedure as the procedure used for the examples of the invention.

The results of the examples of the invention are presented in Table 3 and the results of the comparative examples, in Table 6.

The examples of the invention show a low swelling of the negative electrode in the charged state. Indeed, the thickness variation between the charged and discharged states is less than 15% (comprised between 5% and 11%). Moreover, the volumetric capacity of the negative electrodes of the examples of the invention is high, greater than 710 mAh/cm³.

Comparative Examples 1 and 2 do not contain lithium-metal in the charged state, which corresponds to a value of k equal to 1. The volumetric capacity of such electrodes is significantly lower (less than 600 mAh/cm³).

The comparative example 3 has a value of k<1 (k=0.5) with a high value of R (>7). It is also noted that the volumetric capacity of the electrode is low (472 mAh/cm³)

The comparative example 4 shows a value of k>1 (k=0.5) with a low value of R (R=0.3). In such case, it can be seen that the capacity is high (737 mAh/cm³) but that the swelling during the charge process is very high: 66%, which is detrimental to the operation of the accumulator.

Therefore, unlike the comparative examples, the examples of the invention make it possible both to achieve high volumetric capacities for the negative electrode while avoiding high swelling of the negative electrode during the charge process.

### DESCRIPTION OF THE EXAMPLES OF THE INVENTION

TABLE 1

| | | | | | % | |
|---|---|---|---|---|---|---|
| | | % mass | electrolyte | | (weight) | |
| | molar | electrolyte | particle | Material | material | |
| | composition | in the | diameter | forming | forming | % |
| Example | of the | electrode | D50* | lithium | lithium | carbon |
| no. | electrolyte | before TT | (μm) | alloys | alloys | black |
| Ex1 | Li₃PS₄ | 30 | 1 | Si | 2 | 2 |
| Ex2 | Li₃PS₄ | 30 | 3 | Si | 3 | 2 |
| Ex3 | Li₃PS₄ | 30 | 5 | Si | 1 | 2 |
| Ex4 | Li₃PS₄ | 30 | 3 | Si | 5 | 2 |
| Ex5 | Li₃PS₄ | 30 | 0.5 | Si | 3 | 2 |
| Ex6 | Li₃PS₄ | 30 | 3 | Si | 3 | 2 |
| Ex7 | Li₃PS₄ | 40 | 3 | Si | 3 | 2 |
| Ex8 | Li₃PS₄ | 30 | 3 | Si | 3 | 2 |
| Ex9 | (Li₃PS₄)_{0.8}(LiI)_{0.2} | 50 | 3 | Ag | 3 | 2 |
| Ex10 | Li₆PS₅Cl | 35 | 3 | Zn | 3 | 5 |
| Ex11 | Li₃PS₄ | 55 | 3 | Si | 3 | 2 |

*D50 measured with a laser granulometer

TABLE 2

| | | Total | | | | | |
|---|---|---|---|---|---|---|---|
| | | capacity | | Lithiable | | | |
| | | of the | | material | k = CMAT | | |
| | final | positive | | grammage | act | | |
| Example | porosity | electrode | % | (GR + NC + alloy) | negative/ | | |
| no. | (%) | (mAh/cm2) | graphite | (mg/cm2) | Cpositive | R | 100*R(1 − k)C + *4.85/e |
| Ex1 | 30 | 4 | 61 | 4.184 | 0.50 | 1.4 | 30 |
| Ex2 | 40 | 4 | 64 | 3.043 | 0.40 | 1.2 | 40 |
| Ex3 | 25 | 4 | 66 | 5.746 | 0.60 | 1.7 | 25 |
| Ex4 | 10 | 4 | 62 | 5.048 | 0.80 | 1.0 | 10 |
| Ex5 | 30 | 4 | 64 | 3.804 | 0.50 | 1.2 | 30 |
| Ex6 | 35 | 4 | 64 | 3.804 | 0.50 | 1.5 | 35 |
| Ex7 | 40 | 4 | 54 | 3.622 | 0.50 | 2.1 | 40 |
| Ex8 | 44 | 4 | 64 | 3.804 | 0.50 | 2.1 | 44 |
| Ex9 | 30 | 4 | 44 | 3.393 | 0.50 | 1.5 | 30 |
| Ex10 | 15 | 4 | 56 | 5.637 | 0.50 | 0.8 | 15 |
| Ex11 | 25 | 4 | 39 | 2.605 | 0.40 | 0.8 | 25 |

### Results with Regard to the Example

TABLE 3

| | min swelling of | volumetric capacity in |
|---|---|---|
| | the negative | the charged state |
| Example no. | electrode (%) | (mAh/cm³) |
| Ex1 | 6 | 851 |
| Ex2 | 6 | 1072 |
| Ex3 | 6 | 711 |
| Ex4 | 11 | 926 |
| Ex5 | 7 | 992 |
| Ex6 | 6 | 925 |
| Ex7 | 5 | 763 |
| Ex8 | 5 | 804 |
| Ex9 | 5 | 796 |
| Ex10 | 11 | 731 |
| Ex11 | 11 | 919 |

### Description of the Comparative Examples

TABLE 4

| | | % mass | | | % | |
|---|---|---|---|---|---|---|
| | | electrolyte | | | (weight) | |
| | molar | In the | electrolyte | Material | material | % |
| | composition | front | particle | forming | forming | (weight) |
| Example | of the | electrode | diameter | lithium | lithium | carbon |
| no. | electrolyte | TT | D50* (μm) | alloys | alloys | black |
| Ex | Li₃PS₄ | 30 | 1 | none | 0 | 2 |
| Comp 1 | | | | | | |
| Ex | Li₃PS₄ | 30 | 1 | Si | 5 | 2 |
| Comp 2 | | | | | | |
| Ex | Li₃PS₄ | 30 | 1 | Si | 2 | 2 |
| Comp 3 | | | | | | |
| Ex | Li₃PS₄ | 30 | 1 | Si | 2 | 2 |
| Comp 4 | | | | | | |

*D50 measured with a laser granulometer

TABLE 5

| | | Total | | | | | |
|---|---|---|---|---|---|---|---|
| | | capacity | | Lithiable | | | |
| | | of the | | material | k = CMAT | | |
| | final | positive | % | grammage | act | | |
| Example | porosity | electrode | (weight) | (GR + NC + alloy) | negative/ | | |
| no. | (%) | (mAh/cm2) | graphite | (mg/cm2) | Cpositive | R | 100*R(1 − k)C + *4.85/e |
| Ex | 30 | 4 | 67 | 10.989 | 1:00 | | |
| Comp 1 | | | | | | | |
| Ex | 30 | 4 | 62 | 6.304 | 1:00 | | |
| Comp 2 | | | | | | | |
| Ex | 70 | 4 | 65 | 4.240 | 0.50 | 7.1 | 70 |
| Comp 3 | | | | | | | |
| Ex | 10 | 4 | 65 | 4.240 | 0.50 | 0.3 | 10 |
| Comp 4 | | | | | | | |

### Results with Regards to the Comparative Examples

TABLE 6

| | mini swelling of | volumetric capacity in |
|---|---|---|
| | the negative | the charged state |
| Example no. | electrode (%) | (mAh/cm³) |
| Ex Comp 1 | 5 | 351 |
| Ex Comp 2 | 8 | 589 |
| Ex Comp 3 | 3 | 397 |
| Ex Comp 4 | 66 | 737 |

1. A mixed porous negative electrode comprising graphite and solid electrolyte particles, wherein:
during the charging process, said electrode further comprises:
lithium-metal or a lithium-rich phase within the porosity thereof and
lithium in the form of lithiated graphite,
such that the electrode has a porosity comprised between 10 and 60%.

2. The electrode according to claim 1 such that the electrode further comprises a material which forms lithium alloys, preferentially silicon.

3. The electrode according to claim 1, wherein the graphite is coated with an element forming lithium alloys, preferentially selected from silicon, zinc, aluminum, silver, magnesium, tin, or compounds containing such elements.

4. The electrode according to claim 1 wherein the solid electrolyte is a sulfide.

5. The electrode according to claim 4, wherein said sulfide electrolyte selected from the group consisting of:
all phases [(Li₂S)_{y}(Li₂O)ₜ(P₂S₅)_{t-y-t}]_{(1-z)}(LiX)_{z} with X representing a halogen element; 0<y<1; 0<z<1; 0<t<1
argyrodites such as Li₆PS₅X, with X=Cl, Br, I, or Li₇P₃S₁₁;
Sulfide electrolytes having the crystallographic structure equivalent to the compound Li₁₀GeP₂S₁₂;
Li₃PS₄.

6. The electrode according to claim 1, wherein the electrode comprises a porosity comprised between 10 and 60%, preferentially between 30 and 50%,

7. The electrode according to claim 1, such that the electrode comprises pore size less than 300 nm.

8. A method for preparing an electrode according to claim 1, comprising the step of mixing graphite which is, if appropriate, precoated beforehand, solid electrolyte particles and a pore-forming agent, and then a treatment removing the pore-forming agent.

9. An all-solid electrochemical cell comprising a porous negative electrode according to claim 1, and a positive electrode, such that the ratio k=C_{negative material}/Cₚₒₛᵢₜᵢᵥₑ is comprised between 0.2 and 0.95, preferentially between 0.5 and 0.9,
where C_{negative material} is the sum of the capacity of graphite and of a part of the capacity of all lithiable materials present at the negative electrode in the discharged state, the part of the capacity considered is that the capacity the potential of which, measured during a discharge at C/100, is greater than 0.2V vs Li⁺/Li^{○},
the capacities are equal to the products of the area density of each active material multiplied by the specific capacity (the area densities being expressed in g/cm² and the specific capacities in mAh/g, the active materials of the negative electrode including graphite as well as the other lithiable materials), and where Cₚₒₛᵢₜᵢᵥₑ represents the capacity of the positive electrode in mAh/cm².

10. The electrochemical cell according to claim 9, such that the porosity of the electrode in the discharged state expressed in % is equal to 100*R·(1−k)·Cₚₒₛᵢₜᵢᵥₑ*4.85/e where:
Cₚₒₛᵢₜᵢᵥₑ represents the areal capacity of the positive electrode in mAh/cm²;
e represents the thickness of the negative electrode in the discharged state, expressed in μm;
R represents a number between 0.6 and 3, preferentially between 1.1 and 1.7; and
k is as defined in claim 9.

11. The all-solid electrochemical cell comprising a porous negative electrode according to claim 1 and comprising an intermediate layer comprised between the negative electrode and a solid electrolyte layer, the layer mainly containing fine amorphous carbon powder and a compound forming alloys with lithium

12. An electrochemical module comprising a stack of at least two elements defined according to claim 9, each element being electrically connected with one or a plurality of other elements.

13. A battery comprising one or a plurality of modules according to claim 12.
